(19) United States
(12) Patent Application Publication
(10) Pub. No.: US 2023/0322600 A1
(43) Pub. Date: Oct. 12, 2023

(54) WATER SOFTENER, HUMIDIFIER BASE, AND HUMIDIFIER

(71) Applicant: Gree Electric Appliances, Inc. of Zhuhai, Zhuhai City (CN)

(72) Inventors: Zhirong LIN, Zhuhai (CN); Yang HE, Zhuhai (CN); Daying LAI, Zhuhai (CN); Donghai LIU, Zhuhai (CN); Haosheng LIN, Zhuhai (CN); Shuangshuang TAN, Zhuhai (CN)

(21) Appl. No.: 18/042,287

(22) PCT Filed: Aug. 18, 2021
(86) PCT No.: PCT/CN2021/113318

§ 371 Date: Feb. 20, 2023

(30) Foreign Application Priority Data
Dec. 28, 2020 (CN) 202011580423.7

(51) Int. Cl. C02F 5/00; F24F 6/12; F24F 13/20

(52) U.S. Cl. CPC C02F 5/00; F24F 6/12; F24F 13/20; C02F 2201/002

(57) ABSTRACT

Some embodiments of the present disclosure provide a water softener, a humidifier base, and a humidifier. The water softener includes: a housing internally provided with a resin cavity and sequentially provided with a water inlet and a water outlet along a flowing direction of a water flow; a snap provided on the housing; and a positioning column provided on the end of the housing corresponding to the water inlet and extending toward a direction away from the housing. By providing the snap and the positioning column, when the water softener needs to be assembled, it is merely required to mount the snap and the positioning column to the corresponding parts of one humidifier; in this case, a water flow will enter the water softener through the water inlet to implement a subsequent water softening operation.

### CROSS-REFERENCE TO RELATED APPLICATION

The present disclosure claims priority to Chinese patent application No. 202011580423.7, filed to the China National Intellectual Property Administration on Dec. 28, 2020, and entitled “Water Softener, Humidifier Base, and Humidifier”, the disclosure of which is hereby incorporated by reference in its entirety.

### TECHNICAL FIELD

The present disclosure relates to a technical field of humidifying devices, and in particular to a water softener, a humidifier base and a humidifier.

### BACKGROUND

An air humidifier is a very common electric appliance in daily life. The air humidifier is usually provided with an ultrasonic transducer internally. The ultrasonic transducer itself oscillates liquid water, so as to convert liquid water into water mist.

The humidifiers in the art known to inventors have higher requirements on the quality of water entering the inside of the air humidifier. If the used water is too hard, the ultrasonic transducer will be blocked, which causes adverse effects on the production of water mist later. Therefore, in order to ensure the stable and efficient operation of the air humidifier itself, it is usually required to directly add purified water to the air humidifier. However, the cost of purified water is high, and for many home users, they need to go to a specific place to obtain purified water, which ultimately affects the user experience.

Therefore, the art known to inventors provides an air humidifier, which is internally integrated with a water softener, so as to soften the hard water. However, the water softener in the related art is integrated in the air humidifier, and is directly connected with a water tank through a water pipe and other structures. When the water softener itself is damaged and blocked, the above structure is not convenient for disassembly.

### SUMMARY

Therefore, the technical problem to be solved by the present disclosure is to overcome the defect in the art known to inventors that a water softener in an air humidifier is not convenient for disassembly.

To this purpose, some embodiments of the present disclosure provide a water softener, which includes: a housing internally provided with a resin cavity and sequentially provided with a water inlet and a water outlet along a flowing direction of a water flow; a snap disposed on the housing; and a positioning column provided on an end of the housing corresponding to the water inlet and extending toward a direction away from the housing.

In some embodiments, the snap is disposed on a top position of the housing.

In some embodiments, an annular bulging part is disposed on a part of the housing corresponding to the water inlet, and the annular bulging part extends toward the direction away from the housing.

In some embodiments, the water softener includes a sealing ring, the sealing ring is disposed on the annular bulging part.

In some embodiments, an edge of the annular bulging part is provided with a stop flange which is configured to prevent the sealing ring from falling out.

In some embodiments, wherein the water softener includes a plurality of annular sealing edges, the plurality of layers of annular sealing edges are disposed on the outer sidewall of the sealing ring.

In some embodiments, the water softener also includes: a holding part disposed on a position of the housing corresponding to the water outlet.

In some embodiments, the holding part extends away from the housing in a shape of a plate.

In some embodiments, a supporting bar is disposed under the housing.

Some embodiments of the present disclosure also provides a humidifier base, which includes: a lower catchment area; a water softening area connected with the lower catchment area and disposed at the downstream of the lower catchment area; and a mist forming area connected with the water softening area and disposed at the downstream of the water softening area. The water softener provided by some embodiments of the present disclosure is disposed in the water softening area, wherein the humidifier base includes a connecting plate, the connecting plate is disposed in the water softening area, a water passing hole is disposed on a position of the connecting plate corresponding to the water inlet, and the water softener is detachably disposed on the connecting plate through the snap.

In some embodiments, the connecting plate is provided with a positioning hole, and the positioning column is suitable to be embedded in the positioning hole.

In some embodiments, the annular bulging part of the water softener is configured to be embedded in the water passing hole.

In some embodiments, the humidifier base includes a plurality of sealing rings, the annular bulging part and/or a corresponding part of the water passing hole is provided with at least one sealing ring of the plurality of sealing rings.

In some embodiments, along a flowing direction of a water flow in the humidifier base, the lower catchment area, the water softening area and the mist forming area decrease in height successively.

Some embodiments of the present disclosure also provides a humidifier, which includes: a humidifier base provided by some embodiments of the present disclosure; a water tank disposed on the humidifier base; and a plurality of water discharge devices. The water tank and the lower catchment area are respectively provided with at least one water discharge device of the plurality of water discharge devices.

The technical solutions of the present disclosure have the following advantages:

Firstly, the water softener provided by some embodiments of the present disclosure includes: a housing internally provided with a resin cavity and sequentially provided with a water inlet and a water outlet along a flowing direction of a water flow; a snap disposed on the housing; and a positioning column disposed on the end of the housing corresponding to the water inlet and extending toward a direction away from the housing.

By providing the snap and the positioning column, when the water softener needs to be assembled, it is merely required to mount the snap and the positioning column to the corresponding parts of a humidifier; in this case, a water flow will enter the water softener through the water inlet to implement a subsequent water softening operation.

In the present disclosure, the disassembly and mounting of the water softener can be achieved by means of the snap, and the positioning of the water softener can be achieved by means of the positioning column, thus facilitating ensuring the mounting stability of the water softener.

Secondly, in the water softener provided by the present disclosure, an annular bulging part is disposed on the part of the housing corresponding to the water inlet, and the annular bulging part extends toward the direction away from the housing.

By providing the annular bulging part, the water inlet of the water softener can be stably connected with the humidifier base, so as to prevent a water flow from flowing out of the water softener and causing adverse effects on a normal water softening operation.

Thirdly, in the water softener provided by the present disclosure, the annular bulging part is provided with a sealing ring.

By providing the sealing ring, the sealing performance of the whole water softener can be effectively improved, and then it is helpful to improve the purifying effect of the whole water softener.

Fourthly, the water softener provided by the present disclosure also includes: a holding part disposed on the position of the housing corresponding to the water outlet. By providing the holding part, it is helpful to improve the mounting and disassembly of the water softener itself, and convenient for related personnel to operate.

Fifthly, in the water softener provided by the present disclosure, a supporting bar is disposed under the housing. By providing the supporting bar, the supporting bar itself can hold up the water softener, so that there is a certain gap under the housing of the water softener, preventing water from accumulating under the water softener to cause water pollution.

Sixthly, the humidifier base provided by the present disclosure includes: a lower catchment area; a water softening area connected with the lower catchment area and disposed at the downstream of the lower catchment area; and a mist forming area connected with the water softening area and disposed at the downstream of the water softening area. The water softener provided by the present disclosure is disposed in the water softening area, the water softening area is provided with a connecting plate, a water passing hole is disposed on the position of the connecting plate corresponding to the water inlet, and the water softener is detachably disposed on the connecting plate through the snap.

Seventhly, in the humidifier base provided by the present disclosure, the connecting plate is provided with a positioning hole, and the positioning column is suitable to be embedded in the positioning hole.

Through the combination of the positioning hole and the positioning column, the water softener can be pre-installed, thus facilitating a fixing operation of the humidifier itself; at the same time, through the positioning hole, the water flowing through the connecting plate can stably enter into the water softener, which is helpful to improve the purifying effect.

### BRIEF DESCRIPTION OF THE DRAWINGS

In order to describe the technical solutions in specific implementation modes of the present disclosure or the related art more clearly, the drawings required to be used for descriptions about the specific implementation modes or the related art will be simply introduced below. It is apparent that the drawings described below are only some implementation modes of the present disclosure. Those of ordinary skill in the art may further obtain other drawings according to these drawings without creative work.

FIG. 1 illustrates a structural schematic diagram of a humidifier base provided by the present disclosure;

FIG. 2 illustrates a structural schematic diagram of a first water softener provided by the present disclosure;

FIG. 3 illustrates a structural schematic diagram of a sealing ring on the water softener provided in FIG. 2;

FIG. 4 illustrates a structural schematic diagram of an annular bulging part provided in FIG. 2;

FIG. 5 illustrates an assembly diagram of a second water softener provided by the present disclosure;

FIG. 6 illustrates an assembly diagram of a third water softener provided by the present disclosure;

FIG. 7 illustrates a structural schematic diagram of a second water softener provided by the present disclosure;

FIG. 8 illustrates an assembly diagram of a second or third water softener provided by the present disclosure;

FIG. 9 illustrates a structural schematic diagram of a fourth water softener provided by the present disclosure;

FIG. 10 illustrates a structural schematic diagram of a humidifier base corresponding to the fourth water softener provided by the present disclosure;

FIG. 11 illustrates an assembly diagram of a first water softener provided by the present disclosure;

FIG. 12 illustrates a structural schematic diagram of a fifth water softener provided by the present disclosure;

FIG. 13 illustrates a structural schematic diagram of a humidifier base corresponding to a PTC heater provided by the present disclosure;

FIG. 14 illustrates a structural schematic diagram of a PTC heater provided by the present disclosure;

FIG. 15 illustrates an assembly diagram of a PTC heater and a heater snap provided by the present disclosure;

FIG. 16 illustrates an installation diagram of a PTC heater in a humidifier base provided by the present disclosure;

FIG. 17 illustrates a structural schematic diagram of a misting venting hole and a scale removal hole in a humidifier base provided by the present disclosure;

FIG. 18 illustrates an assembly diagram of a mist venting plate and a scale removal plate provided by the present disclosure;

FIG. 19 illustrates a structural schematic diagram of a mist venting plate or a scale removal plate provided by the present disclosure;

FIG. 20 illustrates an installation diagram of a failure detection device provided by the present disclosure;

FIG. 21 illustrates an enlarged view of area X in FIG. 20;

FIG. 22 illustrates a side view of a failure detection device provided by the present disclosure;

FIG. 23 illustrates a front view of a failure detection device provided by the present disclosure;

FIG. 24 illustrates a structural schematic diagram of a lug boss provided on a water softener provided by the present disclosure;

FIG. 25 illustrates a section view of a lug boss provided on a water softener provided by the present disclosure;

FIG. 26 illustrates a first structural schematic diagram of a compacting structure provided by the present disclosure; and

FIG. 27 illustrates a second structural schematic diagram of a compacting structure provided by the present disclosure.

### DESCRIPTIONS OF THE REFERENCE SIGNS

1, humidifier base; 2, lower catchment area; 3, float; 4, water softening area; 5, mist forming area; 6, water passing gap; 7, ultrasonic generator; 8, blow-off nozzle; 9, water trough plate; 11, second snap; 12, positioning sag;
10, water softener; 101, housing; 102, water inlet; 103, water outlet; 104, annular bulging part; 1041, stop flange; 105, sealing ring; 1051, annular sealing edge; 106, external screw threads; 107, first magnetic part; 108, connecting sealing ring; 109, supporting bar; 110, first snap; 111, positioning lug boss; 1111, first positioning face; 112, cantilever; 113, snap; 1131, bulge; 114, holding part; 115, positioning column; 116, bulging part;
1a, connecting plate; 1e1, water passing hole; 1a2, connecting sleeve; 1a3, positioning hole;
1b, bar; 1b1, base; 1b2, cover plate; 1b3, rotating shaft; 1b4, support; 1b5, filtering screen; 1b6, flow channel;
1c, PTC heater; 1c1, main body; 1c2, heating piece; 1c3, heater snap; 1c4, extending part; 1c41, positioning through hole; 1c5, waterproof wire; 1c6, wiring slot;
1d, misting venting hole; 1d1, scale removal hole; 1d2, mist venting plate; 1d3, scale removal plate; 1d4, bolt; 1d5, annular lug boss; 1d51, gap; 1d6, heat dissipating plate; 1d7, water outlet hole; 1d8, water outlet pipe;
1e, failure detection structure; 1e1, wire column; 1e2, sealing element; 1e3, wire; 1e4, electrode column; 1e5, through hole; 1e6, electrode assembly; 1e7, base plate;
1f, silicone block;
1g, compacting plate; and 1g1, spring.

### DETAILED DESCRIPTION OF THE EMBODIMENTS

The technical solutions of the present disclosure will be described clearly and completely below in combination with the drawings. Apparently, the described embodiments are merely a part of the embodiments of the present disclosure, not all of the embodiments. All other embodiments obtained by those of ordinary skill in the art based on the embodiments in the present disclosure without creative work shall fall within the scope of protection of the present disclosure.

In the descriptions of the present disclosure, it is to be noted that orientation or position relationships indicated by terms “center”, “upper”, “lower”, “left”, “right”, “vertical”, “horizontal”, “inner”, “outer” and the like are orientation or position relationships shown in the drawings, are adopted not to indicate or imply that indicated devices or components must be in specific orientations or structured and operated in specific orientations but only to conveniently describe the present disclosure and simplify descriptions. In addition, the terms “first”, “second” and “third” are used for descriptive purposes only and are not to be construed as indicating or implying relative importance.

In the description of the present disclosure, it is to be noted that unless otherwise definitely specified and limited, terms “mount”, “connected” and “connected” should be broadly understood. For example, the terms may refer to fixed connection and may also refer to detachable connection or integrated connection. The terms may refer to mechanical connection or electrical connection. The terms may refer to direct mutual connection, may also refer to indirect connection through a medium and may refer to communication in two components. For those of ordinary skill in the art, specific meanings of these terms in the present disclosure can be understood according to a specific condition.

In addition, the technical features involved in different embodiments of the present disclosure described below may be combined without conflicts.

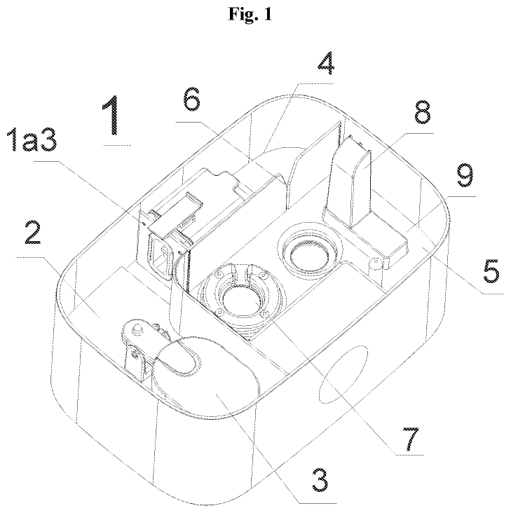

Some embodiments of the present disclosure provide a humidifier, which is configured to humidify the surrounding environment. As shown in FIG. 1, the humidifier includes: a humidifier base 1 and a water tank.

The humidifier base 1 includes: a lower catchment area 2, a water softening area 4, and a mist forming area 5.

The lower catchment area 2 is in contact with the water tank and other structures, and directly collects the water from the water tank. In order to get water from the water tank, a water discharge device is provided in the lower catchment area 2. In some embodiments, the water discharge device is set as a float 3. When the water level in the lower catchment area 2 is high enough, the float 3 is out of contact with the water tank under the action of buoyancy, and the water tank will not supply water to the lower catchment area 2. When the water level of the lower catchment area 2 is lower than a preset liquid level, the float 3 will lose the support of buoyancy, and the float 3 will trigger the water tank, causing the water tank to continue supplying water to the lower catchment area 2.

The water softening area 4 is connected with the lower catchment area 2 and disposed at the downstream of the lower catchment area 2. A water softener 10 is disposed in the water softening area 4.

As shown in FIG. 1, the mist forming area 5 is connected with the water softening area 4 and disposed at the downstream of the water softening area 4. A water passing gap 6 is disposed between the water softening area 4 and the mist forming area 5. The softened water flows into the mist forming area 5 through the water passing gap 6.

In some embodiments of the present disclosure, as shown in FIG. 1, an ultrasonic generator 7 is disposed inside the mist forming area 5, and a piezoelectric ceramic plate is disposed inside the ultrasonic generator 7. The piezoelectric ceramic plate is powered on to generate ultrasonic waves, thus converting liquid water into water mist. In some embodiments of the present disclosure, a blow-off nozzle 8 is disposed in the mist forming area 5, and the formed water mist is exported to the outside through an air outlet. At the same time, a water trough plate 9 is disposed in the mist forming area 5, and the ultrasonic generator 7 and other structures are disposed under the water trough plate 9.

The water tank is disposed on the humidifier base 1. A water outlet 103 of the water tank is disposed corresponding to the lower catchment area 2. An air duct disposed on the water tank is provided corresponding to the blow-off nozzle 8.

In some embodiments of the present disclosure, a plurality of water softeners are disposed in the water softening area 4, a resin chamber is disposed inside the water softener, and water softening resin is disposed in the resin cavity. Hard water can be converted into soft water through the water softening resin. In the present embodiment, the structure of the water softener is not limited.

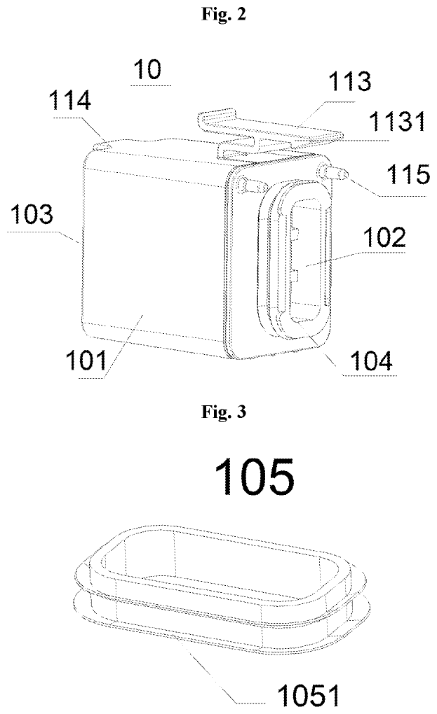

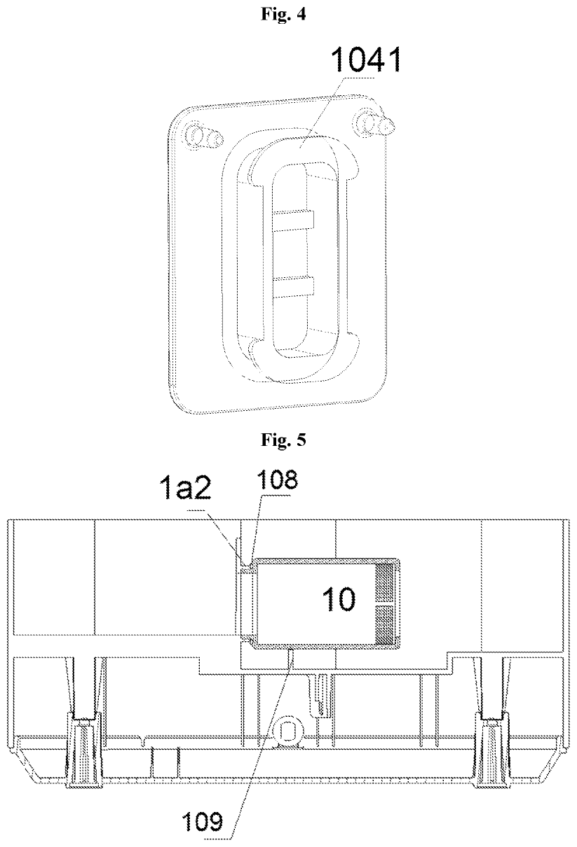

In some embodiments of the present disclosure, as shown in FIG. 2, FIG. 3 and FIG. 4, the water softener includes: a housing 101.

The housing 101 is internally provided with a resin cavity and sequentially provided with a water inlet 102 and a water outlet 103 along a flowing direction of a water flow.

As shown in FIG. 4, an annular bulging part 104 is provided on the part of the housing 101 corresponding to the water inlet 102, and the annular bulging part 104 extends away from the housing 101. In some embodiments of the present disclosure, in order to improve a sealing effect, a sealing ring 105 is sleeved on the annular bulging part 104. At the same time, in order to improve the stability of the sealing ring 105 itself, the edge of the annular bulging part 104 is provided with a stop flange 1041 for preventing the sealing ring 105 from falling out, and the stop flange 1041 is set protruding from the sealing ring 105. In some embodiments of the present disclosure, as shown in FIG. 3, in order to improve the sealing performance of the sealing ring 105, a number of layers of annular sealing edges 1051 are disposed on the outer sidewall of the sealing ring 105. The annular sealing ring 105 is flexible, and when it is squeezed, it deforms, which can effectively improve the sealing effect.

In some embodiments of the present disclosure, in order to realize a fixing operation to the water softener, the water softening area 4 is provided with a connecting plate 1a, and a water passing hole 1a1 is disposed on the part of the connecting plate 1a corresponding to the water inlet 102.

In some embodiments of the present disclosure, in order to realize a mounting operation to the water softener, a variety of different implementation methods are adopted.

In some embodiments of the present disclosure, the water softener is connected by screw threads or magnetic force. The water softener includes: a housing 101 and a connecting part.

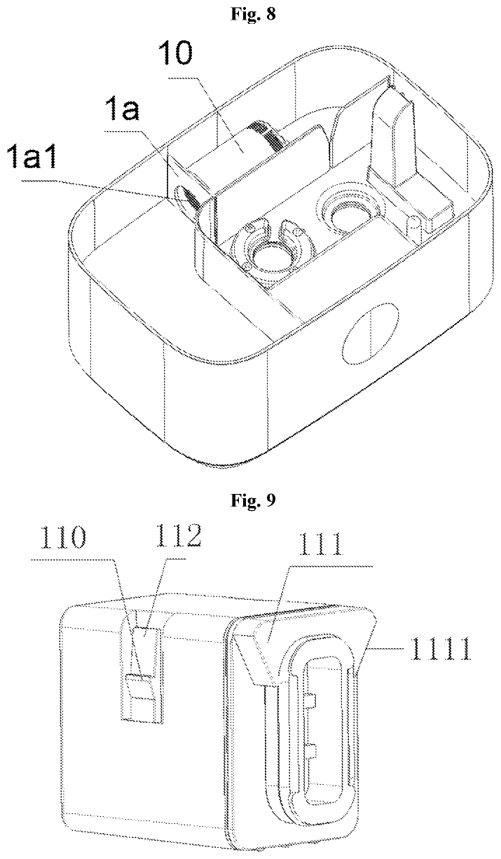

As shown in FIG. 7 and FIG. 8, the housing 101 is internally provided with a resin cavity sequentially provided with a water inlet 102 and a water outlet 103 along a flowing direction of a water flow. Filtering screens are respectively disposed on the water inlet 102 and the water outlet 103. A connecting part is disposed on one end of the housing 101. As shown in FIG. 5 and FIG. 7, the connecting part is external screw threads 106 provided on the outer wall of the connecting part. Correspondingly, a connecting sleeve 1a2 extending toward the water softener is disposed on the water passing hole 1a1, and internal screw threads are disposed on the inner wall of the connecting sleeve 1a2. Through the combination of the external screw threads 106 and the internal screw threads, the mounting operation to the water softener can be realized.

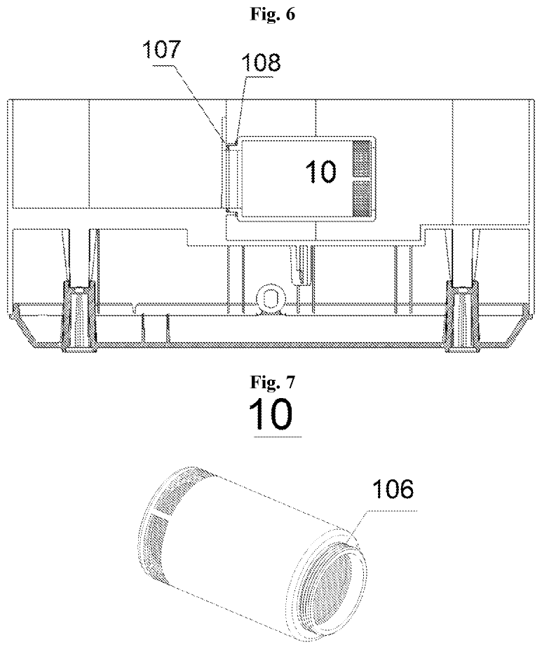

In some embodiments of the present disclosure, as shown in FIG. 6, the connecting part is a first magnetic part 107 disposed on the end of the connecting part. Correspondingly, a connecting sleeve 1a2 extending toward the water softener is disposed on the water passing hole 1a1, and a second magnetic part is disposed on the inner wall of the connecting sleeve 1a2. The polarity of the second magnetic part is opposite to the polarity of the first magnetic part 107. The water softener is mounted on the connecting plate 1a by magnetic force.

In some embodiments of the present disclosure, a connecting sealing ring 108 is disposed between the connecting sleeve 1a2 and the water softener. By providing the connecting sealing ring 108, water leakage between the water softener and the connecting sleeve 1a2 can be avoided. At the same time, as shown in FIG. 5, the mist forming area 5 is provided with a supporting bar 109 extending toward the water softener. By providing the supporting bar 109, the stability of the water softener after assembly can be effectively improved.

In some embodiments of the present disclosure, the housing of the water softener also includes a second connecting part which is disposed on the end of the housing opposite to the first connecting part. As shown in FIG. 7, the second connecting part is disposed on the right end and provided with internal screw threads. The internal screw threads are suitable to be connected with the external screw threads of the first connecting part.

Through the combination of the first connecting part and the second connecting part, a plurality of water softeners can be combined, so as to realize a purifying operation to sewage in a long interval, thus helping to improve a sewage purifying effect. At the same time, through threaded connection, it is helpful to reduce the difficulty of disassembling and assembling a plurality of water softeners, thus improving the operation convenience of users.

In some embodiments of the present disclosure, the water softener is connected by a snap 113 structure. The water softener includes:

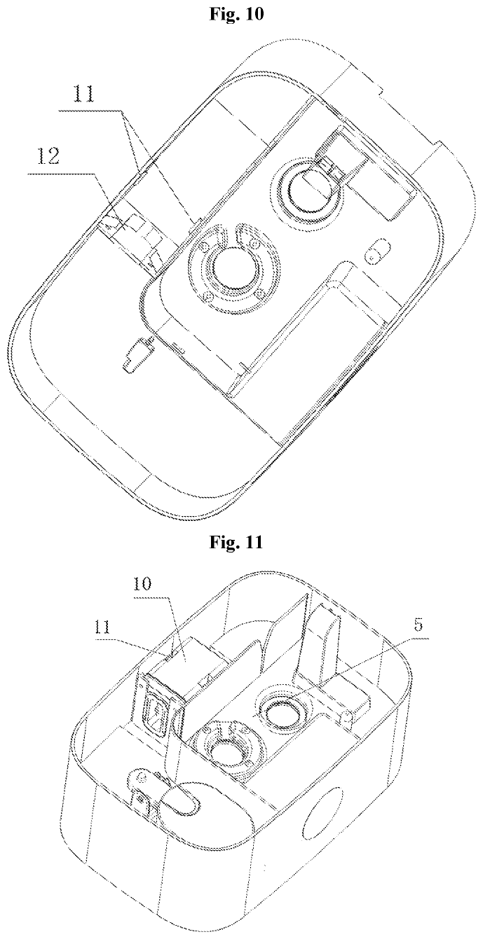

a housing 101 internally provided with a resin cavity and sequentially provided with a water inlet 102 and a water outlet 103 along a flowing direction of a water flow; a first snap 110 disposed on the housing 101, as shown in FIG. 9, FIG. 10 and FIG. 11, the first snap 110 being disposed on the side wall of the housing 101; and a positioning lug boss 111 disposed on the end of the housing 101 corresponding to the water inlet 102, at least part of the outer peripheral face of the positioning lug boss 111 forming a first positioning face 1111.

In some embodiments of the present disclosure, a cantilever 112 is disposed on the side wall of the housing 101, the first end of the cantilever 112 is connected with the housing 101, the first snap 110 is disposed in the middle of the cantilever 112, and the second end of the cantilever 112 is a free end. When the water softener is fixed, the cantilever 112 is squeezed and bends toward the center of the water softener. Correspondingly, a second snap 11 matching with the first snap 110 is disposed on the side wall of the water softening area 4, and the water softener can be mounted through the matching of the first snap 110 and the second snap 11. In some embodiments, the number of the first snaps 110 is one. In some embodiments, the number of the first snaps 110 is two, and the two first snaps 110 are disposed opposite to each other.

At the same time, as shown in FIG. 10 and FIG. 11, in order to match with the positioning lug boss 111, a positioning sag 12 matching with the positioning lug boss 111 is disposed on the upper part of the connecting plate 1a, and the positioning sag 12 is provided with a second positioning face matching with the first positioning face 1111.

The shape of the first positioning face 1111 is not limited. In some embodiments, the first positioning face 1111 includes a first inclined plane and a second inclined plane on two sides of the water inlet 102. The first inclined plane and the second inclined plane are inclined in opposite directions. As shown in FIG. 9, the first inclined plate is inclined at 135°.

In some embodiments, other snap structures are used. As shown in FIG. 2, a snap 113 is disposed on the top position of the housing 101. In some embodiments of the present disclosure, the snap 113 includes a horizontal part and a connecting part. The connecting part and the horizontal part are both made of flexible materials. The end of the horizontal part is provided with a bulge 1131 extending downward, and the horizontal part is connected with the top position of the connecting part through the bulge 1131, thus realizing an action of connection. In some embodiments of the present disclosure, a holding part 114 is also provided on the water softener. The holding part 114 is disposed on the position of the housing 101 corresponding to the water outlet 103. By providing the holding part 114, users can easily mount and disassemble the water softener. The structure of the holding part 114 is not limited, and it is set in the shape of a ring or a hook, as long as users can hold it. In some embodiments of the present disclosure, the holding part 114 extends away from the housing 101 in the shape of a plate.

In some embodiments of the present disclosure, a supporting bar is provided under the housing 101. The supporting bar can hold up the water softener, so that there is a certain gap under the housing 101 of the water softener, preventing water from accumulating under the water softener to cause water pollution.

In some embodiments of the present disclosure, as shown in FIG. 1, in order to realize a precise mounting operation to the water softener, a positioning column 115 is also included, which is disposed on the end of the housing 101 corresponding to the water inlet 102 and extends toward a direction away from the housing 101. Correspondingly, the connecting plate 1a is provided with a positioning hole 1a3, and the positioning column 115 is suitable to be embedded in the positioning hole 1a3. When the water softener needs to be mounted, first the positioning column 115 is embedded into the positioning hole 1a3, and then the snap 113 is mounted on the connecting plate 1a. The positioning column 115 and the positioning hole 1a3 is in interference fit, or fixed by bolts 1d4, thus realizing a stable connection between the water softener and the connecting plate 1a.

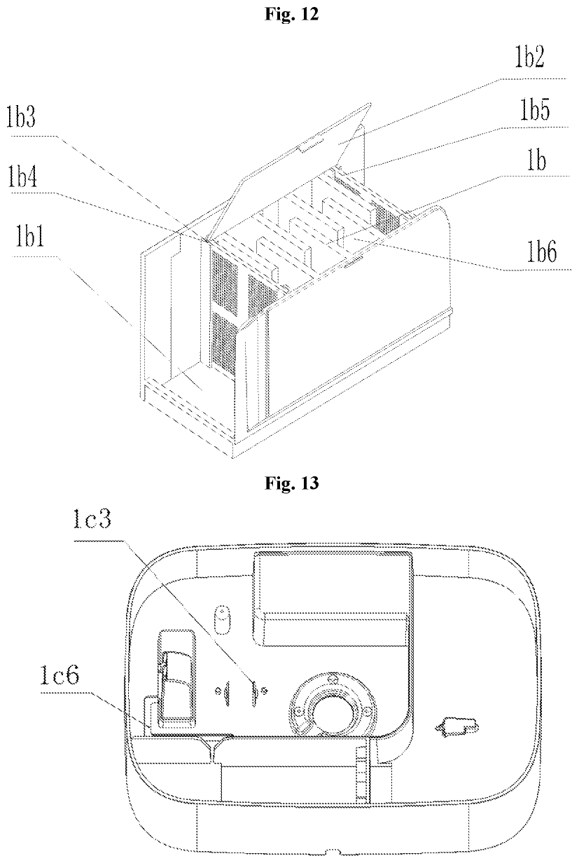

The structure of a second water softener is disposed in the present embodiment. The second water softener is connected with the humidifier base 1 by means of detachable connection or in an integrated molding way. As shown in FIG. 12, the water softener includes:

a housing provided with a water inlet and a water outlet; a flow channel 1b6 suitable for placing water softening resin is provided between the water inlet and the water outlet; and a plurality of bars 1b disposed in the flow channel 1b6 and alternately disposed on two sides of the flow channel 1b6. In some embodiments of the present disclosure, the bars 1b and the base 1b1 are molded by injection molding. In the width direction of the flow channel 1b6, the sum of the lengths of two adjacent bars 1b is greater than the width of the flow channel 1b6.

In this way, when hard raw water passes through the flow channel 1b6 of a softening device, calcium and magnesium ions in the water are absorbed by the water softening resin in a circulating cavity, and sodium ions are released at the same time, so that the softening device can fully soften the water in the circulating cavity. At the same time, because a plurality of bars 1b are disposed alternately on two sides of the flow channel 1b6, and there is an overlap between two adjacent bars 1b, when flowing in the flow channel 1b6, water needs to pass through the water softening resin of the overlap between the two adjacent bars 1b, thus increasing a water softening path and greatly improving a water softening effect. Then, the problems of internal accumulation of scale, blockage in pipes and low humidification efficiency of the humidifier can be prevented to optimize the user experience.

In some embodiments of the present disclosure, as shown in FIG. 12, the housing 101 includes a base 1b1 and a cover plate 1b2. The base 1b1 is provided with the water inlet 102, the water outlet 103 and the flow channel 1b6. The cover 1b2 is suitable to cover the flow channel 1b6. By providing the cover plate 1b2, it is convenient to replace the water softening resin inside the base 1b1. At the same time, a sealing structure is disposed between the cover plate 1b2 and the base 1b1. In some embodiments, the sealing structure is provided with a sealing ring, so as to prevent pollutants outside the water softener from entering into the water softener to pollute the water softening resin.

In some embodiments of the present disclosure, the mounting mode between the cover plate 1b2 and the base 1b1 is not limited, which is a socket joint mode or a rotational connection mode. In some embodiments, the cover plate 1b2 and the base 1b1 can be connected rotationally. In some embodiments, the cover plate 1b2 and the base 1b1 are connected through a rotating shaft 1b3. Correspondingly, the base 1b1 is provided with a support 1b4, and the support 1b4 is provided with a through hole suitable for inserting the rotating shaft 1b3.

In some embodiments, the support 1b4 is provided with an opening. The opening is connected with the through hole, and the diameter of the opening is less than the diameter of the rotating shaft 1b3. In this way, the opening of the through hole on the support 1b4 and the rotating shaft 1b3 are interference fit; when the rotating shaft 1b3 is installed to the through hole, the rotating shaft 1b3 can be directly pressed into the through hole through the opening; and because the opening and the rotating shaft 1b3 are interference fit, the rotating shaft 1b3 will not fall out of the opening. Thus, the mounting process is simplified to facilitate users in using and replacing.

In some embodiments of the present disclosure, the base 1b1 is connected with the end of the cover plate 1b2 away from the axis of rotation by a snap structure. The snap structure includes a snap and a slot. The snap is disposed at one of the base 1b1 and the cover plate 1b2, and the slot is disposed at the other. Through the above setting method, when the cover plate 1b2 is fastened to the base 1b1, the flow channel 1b6 can be completely closed to prevent the leakage of the water softening resin in the flow channel 1b6, and the cover plate 1b2 can be stably mounted on the base 1b1, thus ensuring the normal use of the softening device.

In some embodiments of the present disclosure, the slot is disposed at the cover plate 1b2, and the snap 113 is disposed at the base 1b1. There is an included angle between the end face of the snap 113 close to the slot and the vertical direction. The included angle can play a guiding role. When the cover plate 1b2 is fastened to the base 1b1, the slot can be smoothly fastened to the snap 113 through the end face with a certain included angle of the snap 113.

In some embodiments of the present disclosure, in order to realize a pre-softening operation to the water entering the water softener, the water softener also includes: a filtering screen 1b5 disposed at the water inlet 102 and the water outlet 103. The filtering screen 1b5 is suitable to cover the water inlet 102 and the water outlet 103. In this way, the water softening resin in the flow channel 1b6 can be prevented from leaking out; at the same time, water can be guaranteed to enter the flow channel 1b6 normally. Moreover, impurities in water can also be removed, and then the problems of blockage in pipes and low humidification efficiency of the humidifier can be prevented to optimize the user experience.

In some embodiments of the present disclosure, the base 1b1 is provided with grooves at the water inlet 102 and/or the water outlet 103, and the filtering screen 1b5 is suitable to be embedded in the groove. At the same time, in order to improve the assembly stability between the filtering screen 1b5 and the groove, the filtering screen 1b5 and the groove are interference fit.

In some embodiments of the present disclosure, in order to avoid producing water mist too cold and causing adverse effects on the user experience, a PTC heater 1c is disposed in the humidifier base 1. The setting mode the PTC heater 1c is not limited too much. As an implementation method, the PTC heater 1c is set under a water trough plate 9. In some embodiments, the PTC heater 1c is detachably disposed inside the mist forming area 5 and located above the water trough plate 9. Because the PTC heater 1c is detachably disposed above the water trough plate 9, there is no connected area between the PTC heater 1c and the lower part of the mist forming area 5, so water leakage can be avoided when the sealing structure around the PTC heater is damaged. When the PTC heater 1c is damaged and needs to be replaced, it can be replaced quickly by disassembly setting, thus helping to increase the service life of the humidifier base 1.

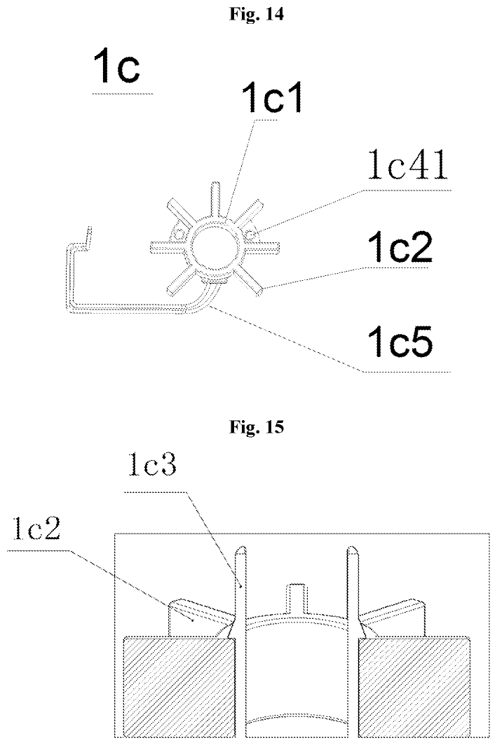

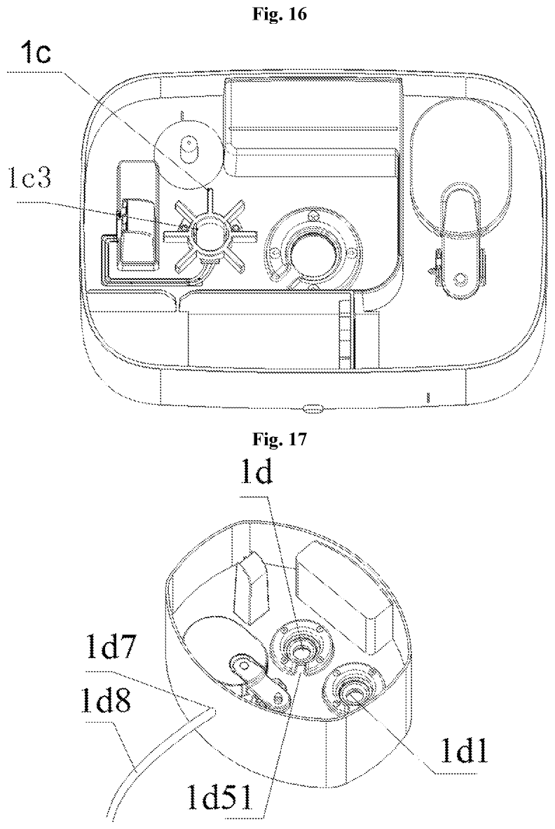

In the humidifier base provided by the present embodiment, as shown in FIG. 13, FIG. 14, FIG. 15 and FIG. 16, the PTC heater 1c includes a main body 1c1 in a closed shape, and a plurality of heating pieces 1c2 radially disposed outside the main body 1c1.

In some embodiments of the present disclosure, the structure of the main body 1c1 is not limited too much, and it is a rectangle, an oval, or a circle, as long as it is in a closed shape.

In some embodiments of the present disclosure, a number of heating pieces 1c2 are disposed on the outer wall of the main body 1c1. Multiple heating pieces 1c2 is arranged at equal intervals or unequal intervals. Through the radial structure, heat can be quickly dissipated to the outside.

In some embodiments of the present disclosure, the mounting mode of the PTC heater 1c is not limited, and the PTC heater 1c is disposed inside the mist forming area 5 by magnetic attraction. In some embodiments of the present disclosure, the PTC heater 1c is connected with the main body 1c1 through a heater snap 1c3. In this way, the PTC heater 1c can be stably fixed. The number of heater snaps 1c3 is not limited, which can be one or more.

As shown in FIG. 15, In some embodiments of the present disclosure, there are two groups of heater snaps 1c3 arranged facing each other. In some embodiments of the present disclosure, the heater snaps 1c3 are disposed in the main body 1c1, and each heater snap 1c3 is abutted against the inner wall of the main body 1c1. At the same time, two groups of heater snaps 1c3 are arranged facing each other, which can better support the main body 1c1.

In some embodiments of the present disclosure, the heater snaps 1c3 is directly disposed at the positions of two quadrant points set oppositely on the main body 1c1, and is also be disposed away from the quadrant points, as long as the main body 1c1 can be fixed.

In some embodiments of the present disclosure, in order to realize a pre-positioning operation to the PTC heater 1c, the area between the adjacent heating pieces 1c2 outside the main body 1c1 is provided with an extending part 1c4, the extending part 1c4 is provided with a positioning through hole 1c41 and/or a positioning column, and the mist forming area 5 is provided with the positioning column and/or the positioning through hole 1c41.

In some embodiments of the present disclosure, the positioning column is disposed on the extending part 1c4, and the positioning through hole 1c41 is disposed in the mist forming area 5; or, the positioning through hole 1c41 is disposed on the extending part 1c4, and the positioning column is disposed in the mist forming area 5; or, both the positioning column and the positioning through hole 1c41 are disposed at the corresponding parts of the extending part 1c4 and the mist forming area 5, as long as a pre-positioning action can be realized.

In some embodiments of the present disclosure, the extending part 1c4 is provided with the positioning through hole 1c41, and the mist forming area 5 is provided with the positioning column.

In some embodiments of the present disclosure, the number of extending parts 1c4 is not limited, and they can be set as one group or multiple groups. A plurality of groups of extending parts 1c4 is set adjacent to each other or at intervals. In some embodiments, as shown in FIG. 16, the extending parts 1c4 are arranged symmetrically relative to a connection line of the quadrant points of the main body 1c1.

In some embodiments of the present disclosure, in order to realize a power supply operation to the PTC heater 1c, the mist forming area 5 is provided with a wire slot 1c6, and a waterproof wire 1c5 is disposed in the wire slot 1c6. One end of the waterproof wire 1c5 extends into the air outlet and the other end is connected to the PTC heater 1c.

In some embodiments of the present disclosure, one end of the waterproof wire 1c5 is connected to a PCB board under the water tank through the air outlet, thus facilitating the PCB board in performing the power supply operation and other operations to the PTC heater 1c. The waterproof wire 1c5 and the wiring slot 1c6 are assembled through interference fit, which can prevent the waterproof wire 1c5 from shaking.

In some embodiments of the present disclosure, after the humidifier is used for a period of time, some scale inevitably produces inside, and the scale will cause adverse effects on the atomization of the ultrasonic generator 7.

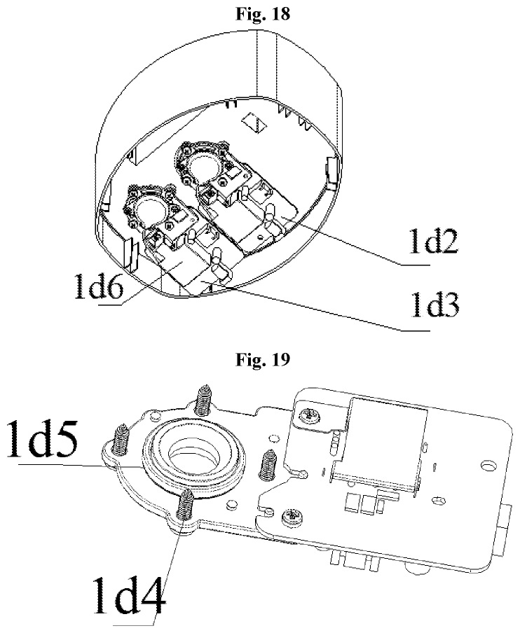

Therefore, in order to avoid the above situation, in some embodiments, as shown in FIG. 17, FIG. 18 and FIG. 19, the humidifier includes: a misting venting hole 1d disposed on the water trough plate 9 and provided with a first piezoelectric ceramic plate; a scale removal hole 1d1 disposed on one side of the misting venting hole 1d and provided with a second piezoelectric ceramic plate; a control device disposed under the water trough plate 9 and respectively connected with the first piezoelectric ceramic plate and the second piezoelectric ceramic plate.

Through the first piezoelectric ceramic plate, the water above the water trough plate 9 can be atomized, so as to convert liquid water into water mist. Through the second piezoelectric ceramic plate, the humidifier itself can play a scale removal function. When the second piezoelectric ceramic plate is started, the ultrasonic vibration generated by the humidifier itself will transfer the power to a medium to produce a cavitation effect, and then the scale inside the housing 101 and around the first piezoelectric ceramic plate can be vibrated to shed, thus playing a role in cleaning the first piezoelectric ceramic plate.

In some embodiments of the present disclosure, vibration frequencies of the second piezoelectric ceramic plate and the first piezoelectric ceramic plate are not limited. When the second piezoelectric ceramic plate starts to work, the first piezoelectric ceramic plate can be controlled to stop working. In some embodiments, in order to realize the synchronous operation of the first and second piezoelectric ceramic plates, in some embodiments, the vibration frequency of the second piezoelectric ceramic plate is less than that of the first piezoelectric ceramic plate.

Through the above setting method, first of all, when the first piezoelectric ceramic plate and the second piezoelectric ceramic plate which are close work, interference or resonance easily producing due to the same frequency can be avoided. At the same time, because the vibration frequency of the second piezoelectric ceramic plate is greater than that of the first piezoelectric ceramic plate, the generated energy can act on the first piezoelectric ceramic plate to the maximum extent, thus helping to remove scale.

In some embodiments of the present disclosure, the first piezoelectric ceramic plate and the second piezoelectric ceramic plate are arranged at a certain distance. In some embodiments, the misting venting hole 1d and the scale removal hole 1d1 are arranged at a distance of 60 mm.

In some embodiments of the present disclosure, the structure of the control device is not limited; it is integrated on a PCB board, and is also arranged independently relative to the first and second piezoelectric ceramic plates. In some embodiments, the control device includes a mist venting plate 1d2 and a scale removal plate 1d3. The first piezoelectric ceramic plate is disposed on the mist venting plate 1d2, and the second piezoelectric ceramic plate is disposed on the scale removal plate 1d3.

In some embodiments of the present disclosure, in order to realize a fixing operation to the mist venting plate 1d2 and the scale removal plate 1d3, the scale removal plate 1d3 and/or the mist venting plate 1d2 are provided with bolts 1d4, and the scale removal plate 1d3 and/or the mist venting plate 1d2 are connected with the water trough plate 9 through the bolts 1d4.

In some embodiments of the present disclosure, as shown in FIG. 19, the bolts are disposed on the mist venting plate 1d2, or on the scale removal plate 1d3, or on both the mist venting plate 1d2 and the scale removal plate 1d3, so as to realizing the fixing operation.

In some embodiments of the present disclosure, in order to avoid water from seeping from the water trough plate 9 through the scale removal hole 1d1 and the mist venting hole 1d, an annular lug boss 1d5 is disposed on the scale removal plate 1d3 and the mist venting plate 1d2. The annular lug boss 1d5 is provided with a gap 1d51, and the outer wall of the annular lug boss 1d5 is provided with a sealing ring 105.

By providing the gap 1d51, the water in the housing 101 can be guided into the first and second piezoelectric ceramic plates, so as to realize the subsequent operations. By providing the sealing ring 105, the gap between the annular lug boss 1d5 and the scale removal hole 1d1 or the mist venting hole 1d can be filled.

In some embodiments of the present disclosure, as shown in FIG. 18, the side of the scale removal plate 1d3 away from the water trough plate 9 is provided with a heat dissipating plate 1d6. Thus, the rapid heat dissipation of the second piezoelectric ceramic plate can be realized, which helps to prevent thermal damage caused by high temperature to the structure around the second piezoelectric ceramic plate.

The materials of the heat dissipating plate 1d6 are not limited too much, as long as they are materials with heat conductivity coefficients, such as iron and copper. In some embodiments of the present disclosure, the heat dissipating plate 1d6 is an aluminum plate. The aluminum plate is relatively stable, and will not rust after prolonged contact with water.

At the same time, the position where the heat dissipating plate 1d6 is disposed under the water trough plate 9 is not limited, as long as a heat conduction effect can be realized. In some embodiments of the present disclosure, the heat dissipating plate 1d6 is disposed under the scale removal hole 1d1. Through the above setting method, the heat generated by the second piezoelectric ceramic plate can be quickly exported to the outside.

In some embodiments of the present disclosure, as shown in FIG. 17, the housing 101 is provided with a water outlet hole 1d7, the water outlet hole 1d7 is connected with a water outlet pipe 1d8, and the water outlet pipe 1d8 is provided with a valve. By providing the water outlet hole 1d7 and the water outlet pipe 1d8, the scale generating after a scale removing action is completed can be led to the outside through the water outlet pipe 1d8, so as to realize the function of automatically removing the scale through flowing water and then save users from manual cleaning.

In some embodiments of the present disclosure, the valve is a solenoid valve, and the water outlet pipe 1d8 is disposed on the outside of the housing 101. When the scale removing action is completed, the solenoid valve is opened to discharge the water containing dirt to the outside.

When a cleaning operation to the humidifier base 1 is started, the scale removing action on the first piezoelectric ceramic plate, the second piezoelectric ceramic plate and the inner wall of the housing 101 can be realized. When it is necessary to remove the scale at the bottom of the housing 101 and clean the mist venting hole 1d and the scale removal hole 1d1, the mist venting hole 1d and the scale removal hole 1d1 need to be completely immersed. If the inner wall of the inner housing needs to be cleaned, it is necessary to control water to the highest level, or separate the humidifier base 1 directly from the water tank, then start the second piezoelectric ceramic plate after manually collecting water, and let the humidifier base 1 sit for a period of time.

In some embodiments of the present disclosure, except the traditional scale removing operation, it is also necessary to monitor the performance of the water softener itself in real time, so as to avoid the complete failure of the water softening resin inside the water softener from affecting the normal water purifying effect.

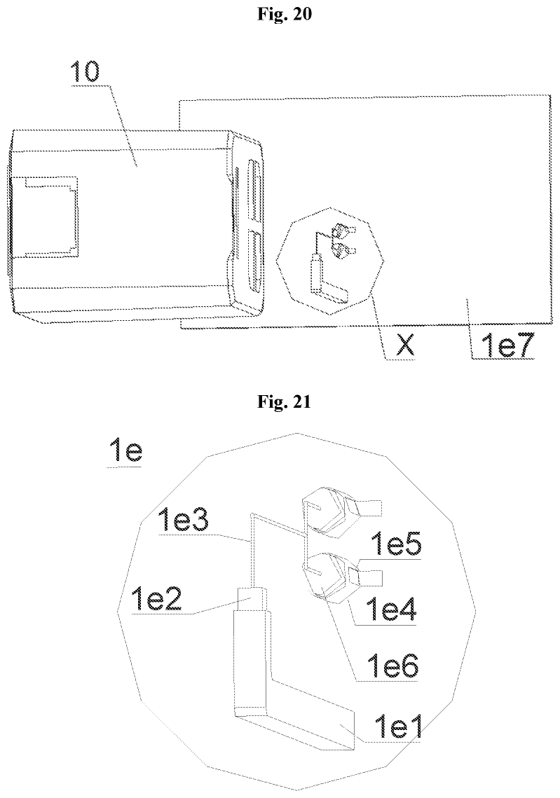

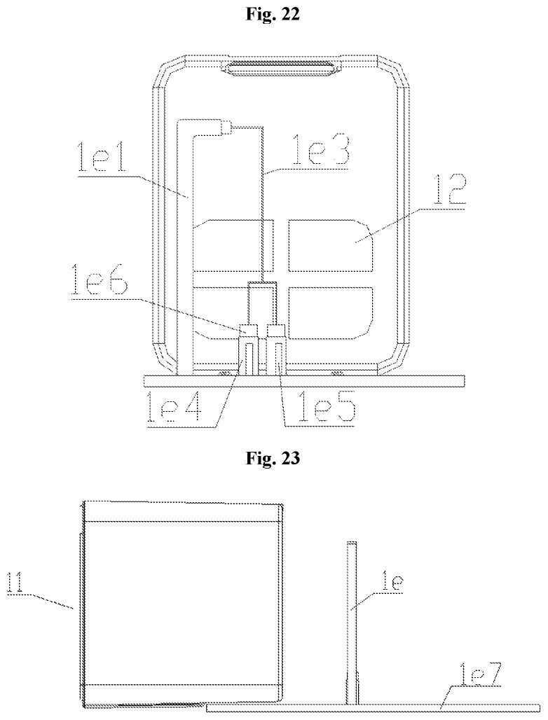

In some embodiments of the present disclosure, as shown in FIG. 20, FIG. 21, FIG. 22 and FIG. 23, a failure detection structure 1e is disposed in the water softening area 4 or the mist venting area. In some embodiments, the failure detection structure 1e is disposed behind the water outlet 103 of the water softener and is suitable for detecting the content of calcium and magnesium ions in liquid medium flowing through the failure detection structure 1e.

In some embodiments of the present disclosure, the failure detection structure 1e includes: an electrode assembly 1e6 which is suitable for at least partially contacting with the liquid medium flowing out of the water outlet 103 in a working state; and a capacitance detection element, which is electrically connected with the electrode assembly 1e6 and suitable for detecting a capacitance value of the electrode assembly 1e6. In some embodiments, the liquid medium includes water, the water filtered through the water softener.

In some embodiments of the present disclosure, by providing the failure detection structure 1e at the downstream of the water outlet 103 of the water softener, the content of calcium and magnesium ions in the liquid medium flowing through the failure detection structure 1e is detected. Through a state change or feedback of the failure detection structure 1e, whether the water softening function fails is judged, thus prompting users to replace the water softener to ensure the water softening effect.

In some embodiments of the present disclosure, the failure detection structure 1e includes: an electrode assembly 1e6 which is suitable for at least partially contacting with the liquid medium flowing out of the water outlet 103 in a working state; and a capacitance detection element, which is electrically connected with the electrode assembly 1e6 and suitable for detecting the capacitance value of the electrode assembly 1e6.

In some embodiments of the present disclosure, the electrode assembly 1e6 includes a positive electrode and a negative electrode.

In some embodiments of the present disclosure, the electrode assembly 1e6 in the working state is made at least partially contact with the liquid medium flowing out of the water outlet 103, and the capacitance detection element is electrically connected with the electrode assembly 1e6. After the capacitance value of the electrode surface changes due to electrolytic adsorption of the calcium and magnesium ions through the electrode assembly 1e6, and a change rate of electrode capacitance is detected through the capacitance detection element, whether the water softening function fails is detected.

The electrode assembly 1e6 can not only electrolytically adsorb the calcium and magnesium ions to cause a change in the capacitance value of the electrode surface, but also electrolytically adsorb ions through the electrode and achieve a scale removing effect. Thus, in some embodiments, the water softener is used as a main unit of the water softening function, and the electrode assembly 1e6 is used as an auxiliary unit of the water softening function, so as to not only judge whether the water softening function of the water softener fails, but also temporarily soften water when the water softening function of the water softener fails.

In some embodiments of the present disclosure, the failure detection structure 1e also includes: a wire 1e3. One end of the wire 1e3 is electrically connected with the electrode assembly 1e6, and the other end is suitable to be electrically connected with a power module.

The wire 1e3 is the wire 1e3 connecting the power module and the electrode assembly 1e6, and the outer layer has waterproof protective plastic. The power module is disposed on the outside of the water softer and does not contact with liquid. In order to prevent the wire 1e3 from contacting with liquid or to prevent the wire 1e3 from guiding liquid to the power module, it is necessary to make the wire 1e3 watertight. In the present embodiment, it is to provide the wire 1e3 in a wire column 1e1 and seal it.

In some embodiments of the present disclosure, the failure detection structure 1e also includes: a wire column 1e1, which is constructed as a hollow cavity structure with open ends and hollow inside. The wire column 1e1 accommodates at least part of the wire 1e3 and is suitable for isolating the wire 1e3 in the wire column 1e1 from the liquid medium.

The wire 1e3 is threaded in the wire column 1e1, and the wire 1e3 is isolated from the liquid medium through the wire column lel. In some embodiments, one end of the wire column 1e1 is fixedly connected with the base plate 1e7, and the wire column 1e1 and the base plate 1e7 are in sealed connection. The hollow cavity of the wire column 1e1 runs through the base plate 1e7, so that the wire 1e3 passes through the base plate 1e7 and reaches the second end of the wire column 1e1 through the hollow cavity of the wire column 1e1.

In some embodiments of the present disclosure, one end of the wire column 1e1 is connected with the outside, and the other end forms a wire outlet suitable for the wire 1e3 to go through. The wire outlet is suitable to be disposed above the highest liquid level of the liquid medium along the direction of gravity.

In some embodiments of the present disclosure, one end of the wire column 1e1 is connected with the outside. The outside is the area outside the base plate 1e7. There is no liquid in this area, which is suitable for placing the power module or control module. The other end of the wire column 1e1 forms a wire outlet suitable for the wire 1e3 to go through. The outlet is disposed above the highest liquid level of the liquid medium along the direction of gravity, so as to prevent the liquid medium from entering the hollow cavity of the wire column 1e1 through the wire outlet and flowing to the outside, thus reducing the damage to the power module and ensure the normal operation of the device. Moreover, the situation where the wire outlet of the wire column 1e1 is immersed in water for a long time to easily cause water leakage is avoided.

In some embodiments of the present disclosure, the failure detection structure 1e also includes: a sealing element 1e2. The sealing element 1e2 is suitable for the wire 1e3 to go through and suitable for sealing the wire outlet.

By providing the sealing element 1e2 at the wire outlet of the wire 1e3, the sealing effect of the wire outlet is further enhanced, and the liquid medium is prevented from entering the wire outlet by accident.

In some embodiments of the present disclosure, the sealing element 1e2 is a plastic element or rubber element. Preferably, the rubber element is silicone rubber. By making the sealing element in a shape matching the shape of the wire outlet and inserting it into the wire outlet, the sealing effect is ensured. And because the position of sealing the wire outlet of the wire column 1e1 is above the highest water level, the general sealing accuracy can meet the requirements without the need to adopt a higher sealing grade, thus reducing the production cost.

In some embodiments of the present disclosure, the failure detection structure also includes: an electrode column 1e4. The electrode column 1e4 at least partially accommodates the electrode assembly 1e6 and limits the electrode assembly 1e6 along the flowing direction of the liquid medium. The electrode column 1e4 as a structure for placing and accommodating the electrode assembly 1e6 can limit the electrode assembly 1e6 along the flow direction of the liquid medium, so as to prevent the electrode assembly 1e6 from swinging around under the impact of the liquid medium, thus ensuring the use effect and avoiding damage.

In some embodiments of the present disclosure, the electrode assembly 1e6 is made of metal materials and made in a cylindrical shape. Correspondingly, the electrode column 1e4 is also made in a cylindrical shape.

In some embodiments of the present disclosure, at least one through hole 1e5 is formed on the electrode column 1e4. The through hole 1e5 is suitable for the liquid medium to penetrate into the electrode column 1e4 and contact with the electrode assembly 1e6.

At least one through hole 1e5 is formed on the electrode column 1e4, so that the electrode column 1e4 is formed into a hollow structure. The hollow structure is to not block the inflow of water, ensure that the liquid medium penetrates into the electrode column 1e4 and contacts with the electrode assembly 1e6 to improve the detection accuracy, and avoid the blockage caused by scale of the electrode assembly 1e6 after long-term use to ensure the detection accuracy.

In some embodiments of the present disclosure, the electrode column 1e4 is at least partially higher than the upper surface of the electrode assembly 1e6. The electrode assembly 1e6 is slightly higher than the electrode column 1e4, thus ensuring full contact between the liquid and the electrode assembly 1e6.

In some embodiments of the present disclosure, the failure detection structure also includes: a control element. The control element is in electrical connection or communication connection with the capacitance detection element. A signal fed back by the capacitance detection element is received through the control element, and combined with a preset capacitance value parameter, it is judged whether the capacitance value on the electrode assembly 1e6 detected by the capacitance detection element exceeds a reasonable range, so as to determine whether the water softening function of the water softener fails.

In some embodiments of the present disclosure, the projection of the wire column 1e1 toward the water softener is misaligned with the water outlet 103. Thus, the wire column 1e1 is not directly in front of the water outlet 103, which does not affect a water discharge speed and thus ensures a water discharge effect.

In some embodiments of the present disclosure, the wire column 1e1 is disposed directly in front of the structure edge of the water softener, thus exposing the position of the water outlet 103.

In some embodiments of the present disclosure, the electrode assembly 1e6 is placed directly facing the water outlet 103 of the water softener, so that the electrode assembly 1e6 is fully in contact with the liquid medium to improve the measurement accuracy.

In the specific working process of the failure detection structure 1e, water enters the water softener from the water inlet and flows out of the water outlet 103 after being filtered by the water softener; the water flowing out contacts with the electrode assembly 1e6 and is acted on by the electrolytic electrode reversely powered on, and then the calcium and magnesium ions in the water that have not been fully filtered are absorbed by the electrode, thus affecting the capacitance value between the electrodes. By detecting the change rate of the capacitance value, if the change rate is almost unchanged or does not increase significantly, it indicates that the water softener works normally; if the change rate of the capacitance value increases significantly, it indicates that the water softener has failed, in this case, the water softening material needs to be replaced. The failure detection structure 1e is not used as the main unit for removing scale, but only plays an auxiliary role. The main function of the failure detection structure 1e is detecting the working condition of the water softener; and when the water softener fails, it can also be used as a temporary water softening unit.

For the water softener in the art known to inventors, the resin inside the water softener is in a loose state before it is soaked. When water enters the water softener, water flow passes through the gap in the water softening resin, making the water softening resin compact under the action of water, and then the overall volume of the water softening resin becomes too small to fully fill the water softener. In this case, there is a certain gap at the top position of the water softening resin, and the water flow cannot interact with the water softening resin when passing through the gap, thus affecting the final water purifying effect. In some embodiments, in order to improve the purifying effect of the water softening resin inside the water softener, the following modes are used.

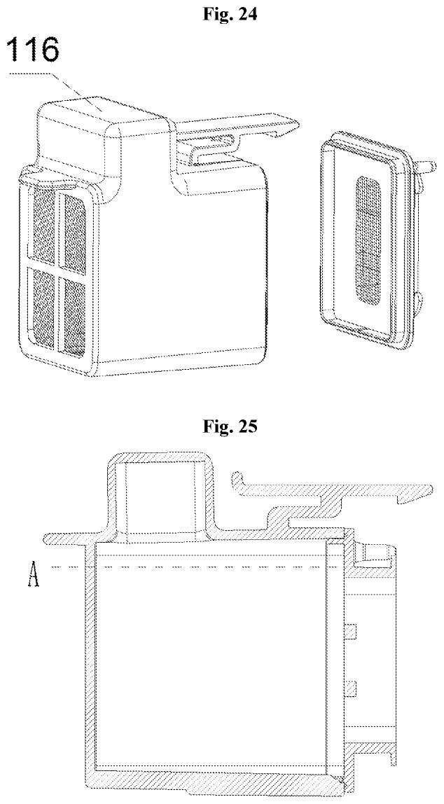

As the first implementation mode, as shown in FIG. 24 and FIG. 25, at least part of the top of the housing 101 is provided with a bulging part 116, and the bulging part 116 bulges away from the central part of the resin cavity. By providing the bulging part 116, more water softening resin is placed in it. When the water softening resin becomes compact under the action of water, the water softening resin in the bulging part 116 structure will feed down while the highest surface of the water softening resin descends, so that the resin is always maintained at a certain height, and thus the water purifying performance of the water softener water can be effectively maintained.

In some embodiments of the present disclosure, because the water softening resin is filled inside the bulging part 116, after the volume of the water softening resin inside the resin cavity shrinks due to contacting with water, the top of the water softening resin will still descend to the position indicated by line A in FIG. 25; in this case, because the top surface of the water softening resin is still above the water inlet 102, the normal water softening operation can still be ensured.

The shape of the bulging part 116 is not limited. In some embodiments of the present disclosure, the bulging part 116 is disposed in a rectangular shape, at the same time, in order to prevent the water softener from cutting users, the side edge at the top of the bulging part 116 is provided with rounded corners. In some embodiments of the present disclosure, four top edges of the bulging part 116 are all provided with the rounded corners.

As the second implementation mode, a compacting structure is disposed inside the housing 101. The compacting structure is disposed above the water softening resin, and the compacting structure is configured to apply a compacting force to the resin and fill the space after the resin shrinks.

After the water softener is used for a period of time, the resin in the housing 101 shrinks, and the compacting structure compacts the resin and fills the space after the resin shrinks, thus eliminating the gap caused by the shrinkage of the resin. The above structure ensures that all water flow entering from the water inlet 102 can be softened by the resin, thus ensuring the softening effect. Therefore, the technical solutions of the present disclosure solve the defect of poor softening effect of the softener of the air humidifier in the related art.

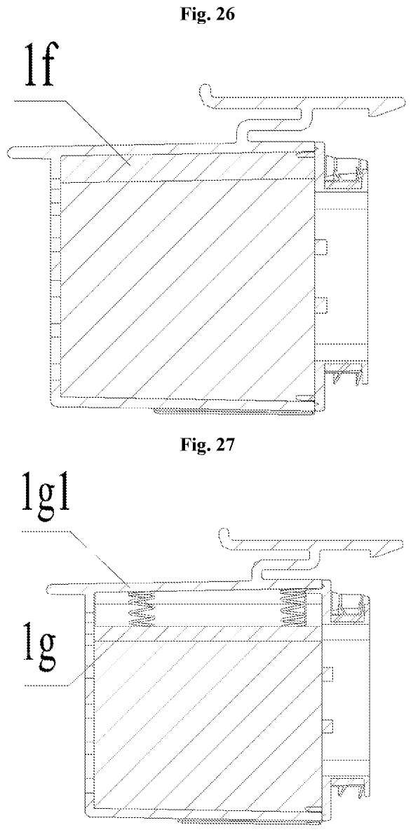

The compacting structure is not limited. As the first implementation mode of the compacting structure, as shown in FIG. 26, the compacting structure is a silicone block 1f, and the silicone block 1f is filled in the space between the water softening resin and the top wall of the housing 101.

As the second implementation mode of the compacting structure, as shown in FIG. 27, the compacting structure includes a compacting plate 1g and an elastic element. The outline of the compacting plate 1g is adapted to the outline of the inner wall of the housing 101. The compacting plate 1g is disposed above the resin. The two ends of the elastic element respectively abut against the top wall of the housing 101 and the upper surface of the compacting plate 1g.

In some embodiments of the present disclosure, the compacting plate 1g extends along the horizontal direction, and the upper edge of the compacting plate 1g is higher than the upper edge of the water inlet 102, so as to ensure that the hard water entering the housing 101 can fully contact with the water softening resin, and then play a better water softening effect.

In some embodiments of the present disclosure, the elastic element is a spring 1g1, and the number of elastic elements is not limited, which can be one or more. In some embodiments, there are multiple elastic elements arranged at intervals.

As the third implementation mode, adjustment is performed from the specific dimension setting of the housing 101. In some embodiments of the present disclosure, the height of the resin cavity and the distance between the top of the water inlet 102 and the top wall of the resin cavity satisfy the following relationship:

$$\frac{z 2}{z 1} \leq k ,$$

where the z1 is the height of the resin cavity, the z2 is the distance between the top of the water inlet 102 and the top wall of the resin cavity, and the k is the shrinkage rate of the resin in the resin cavity, In some embodiments of the present disclosure, the shrinkage rate refers to the shrinkage rate of the resin in the resin cavity along the vertical direction.

In some embodiments of the present disclosure, the value of z1 ranges from 45 mm to 55 mm, the range of z2 ranges from 5 mmm to 15 mm, the width of the housing 101 is in the range of 30 mm to 40 mm, and the length of the housing 101 is in the range of 40 mm to 50 mm.

$$\frac{z 2}{z 1} \leq k .$$

It is apparent that the abovementioned embodiments are only examples for clear description and not intended to limit the implementation modes. Those of ordinary skill in the art may further make variations or modifications of other different forms on the basis of the above descriptions. It is unnecessary and impossible to exhaust all of the implementation modes herein. Apparent variations or modifications derived therefrom also fall within the scope of protection of the present disclosure.

What is claimed is:

1. A water softener, comprising:
a housing internally provided with a resin cavity and sequentially provided with a water inlet and a water outlet along a flowing direction of a water flow;
a snap disposed on the housing; and
a positioning column, disposed on an end of the housing corresponding to the water inlet and extending toward a direction away from the housing.

2. The water softener as claimed in claim 1, wherein the snap is disposed on a top position of the housing.

3. The water softener as claimed in claim 1, wherein an annular bulging part is disposed on a part of the housing corresponding to the water inlet, and the annular bulging part extends toward the direction away from the housing.

4. The water softener as claimed in claim 3, wherein the water softener comprises a sealing ring, wherein the sealing ring is disposed on the annular bulging part.

5. The water softener as claimed in claim 4, wherein an edge of the annular bulging part is provided with a stop flange which is configured to prevent the sealing ring from falling out.

6. The water softener as claimed in claim 5, wherein the water softener comprises a plurality of annular sealing edges, the plurality of annular sealing edges are disposed on an outer sidewall of the sealing ring.

7. The water softener as claimed in claim 1, wherein the water softener further comprising: a holding part disposed on a position of the housing corresponding to the water outlet.

8. The water softener as claimed in claim 7, wherein the holding part extends away from the housing in a shape of a plate.

9. The water softener as claimed in claim 1, wherein a supporting bar is disposed under the housing.

10. A humidifier base, comprising:
a lower catchment area;
a water softening area connected with the lower catchment area and disposed at a downstream of the lower catchment area; and
a mist forming area connected with the water softening area and disposed at a downstream of the water softening area;
the water softener as claimed in claim 1 is disposed in the water softening area, wherein the humidifier base comprises a connecting plate, the connecting plate is disposed in the water softening area, a water passing hole is disposed on a position of the connecting plate corresponding to the water inlet, and the water softener is detachably disposed on the connecting plate through the snap.

11. The humidifier base as claimed in claim 10, wherein the connecting plate is provided with a positioning hole, and the positioning column is suitable to be embedded in the positioning hole.

12. The humidifier base as claimed in claim 10, wherein the annular bulging part of the water softener is configured to be embedded in the water passing hole.

13. The humidifier base as claimed in claim 12, wherein the humidifier base comprises a plurality of sealing rings, the annular bulging part and a corresponding part of the water passing hole; or the annular bulging part or the corresponding part of the water passing hole is provided with at least one sealing ring of the plurality of sealing rings.

14. The humidifier base as claimed in claim 10, wherein along a flowing direction of a water flow in the humidifier base, the lower catchment area, the water softening area and the mist forming area decrease in height successively.

15. A humidifier, comprising:
a humidifier base as claimed in claim 10;
a water tank disposed on the humidifier base; and
a plurality of water discharge devices, wherein the water tank and the lower catchment area are respectively provided with at least one water discharge device of the plurality of water discharge devices.

16. The water softener as claimed in claim 2, wherein an annular bulging part is disposed on a part of the housing corresponding to the water inlet, and the annular bulging part extends toward the direction away from the housing.

17. The water softener as claimed in claim 16, wherein the water softener comprises a sealing ring, wherein the sealing ring is disposed on the annular bulging part.

18. The water softener as claimed in claim 17, wherein an edge of the annular bulging part is provided with a stop flange which is configured to prevent the sealing ring from falling out.

19. The water softener as claimed in claim 18, wherein a plurality of annular sealing edges are disposed on an outer sidewall of the sealing ring.

20. The humidifier base as claimed in claim 12, wherein the water softener comprises a sealing ring, the annular bulging part or a corresponding part of the water passing hole is provided with the sealing ring.
